(19) United States
(12) Patent Application Publication
(10) Pub. No.: US 2018/0131014 A1
(43) Pub. Date: May 10, 2018

(54) Composite Material Separation Plate for Fuel Cell and Method for Manufacturing Same

(71) Applicant: Korea Advanced Institute of Science and Technology, Daejeon (KR)

(72) Inventors: Dai Gil Lee, Daejeon (KR); Dong Young Lee, Daejeon (KR); Jun Woo Lim, Daejeon (KR); Jae Heon Choe, Daejeon (KR); Min Kook Kim, Daejeon (KR); Soo Hyun Nam, Daejeon (KR)

(21) Appl. No.: 15/573,138

(22) PCT Filed: Sep. 1, 2015
(86) PCT No.: PCT/KR2015/009180

§ 371 Date: Nov. 10, 2017

(30) Foreign Application Priority Data
May 12, 2015 (KR) 10-2015-0066124

(51) Int. Cl. H01M 8/0213

(52) U.S. Cl. CPC H01M 8/0213; B82Y 30/00

(57) ABSTRACT

The present invention discloses a composite material separation plate for a fuel cell and a method for manufacturing the same. The disclosed composite material separation plate for a fuel cell according to the present invention is a composite material separation plate for a fuel cell including carbon materials covered with a polymer matrix, and is characterized in that the carbon materials are exposed to the surface of the composite material separation plate. Therefore, the present invention is advantageous in that the physical contact between a sacrificial layer, which is made of a soft material, and the separation plate exposes the carbon materials of the separation plate, thereby lowering the electric contact resistance of the separation plate.

### CROSS-REFERENCE TO RELATED APPLICATION

This application claims priority to Korean Patent Application No. 10-2015-0066124 filed May 12, 2015, the disclosure of which is hereby incorporated in its entirety by reference.

### TECHNICAL FIELD

The present invention relates to a composite material separation plate for a fuel cell and a method for manufacturing the same, and more particularly, to a composite material separation plate for a fuel cell and a method for manufacturing the same in which performance of the fuel cell is improved by reducing electric contact resistance of a separation plate without damage to carbon materials.

### BACKGROUND ART

Fuel cells are energy conversion devices that directly convert chemical energy generated by oxidation of fuel into electrical energy. The fuel cells have been developed in various forms and structures depending on the type of fuel used in a cell. A polymer electrolyte membrane fuel cell (PEMFC) uses a polymer membrane having a hydrogen ion exchange characteristic as an electrolyte. An attempt is actively made, to apply the PEMFC to various fields including a power source of an eco-friendly vehicle, self-power generation, mobility and military power sources, and the like due to an advantage in that the PEMFC has high efficiency and large current density and output density, has a short start-up time, and has rapid response characteristics to a load change.

FIG. 1 is a diagram schematically illustrating a configuration of a polymer electrolyte fuel cell stack.

Referring to FIG. 1, a membrane electrode assembly (MEA) is located at the innermost part of one unit cell unit constituting a polymer electrolyte membrane fuel cell (PEMFC) stack. The membrane electrode assembly is constituted by a solid polymer electrolyte membrane 60 which serves to prevent oxygen and hydrogen from contacting each other while serving as a carrier of a hydrogen proton and a catalyst layer coated on both surfaces of the polymer electrolyte membrane 60 so that the hydrogen and the oxygen may react with each other, that is, a cathode 61 and an anode 62.

A gas diffusion layer (GDL) 40, a gasket 41 preventing gas and a cooling liquid from leaking between separation plates 30, and the like are sequentially stacked at an outer part of the membrane electrode assembly, that is, an outer part where the cathode and the anode are located, the separate plate 30 with a flow field to supply fuel and discharge water generated by the reaction is located outside the gas diffusion layer (GDL) 40, and an end plate 50 for supporting the respective components is coupled to the outermost side.

The separation plate 30 is an electric conductive plate called a bipolar plate or a flow field plate. One surface of the separation plate 30 has an anode side channel and the other surface has a cathode side channel.

In order to reduce electric contact resistance between the components, the end plate 50 is generally bolted using a tie rod. The end plate 50 has an outlet and an inlet of reaction gas, a cooling water circulation hole, and a connector for outputting power.

Meanwhile, in the anode 62 of the PEMFC, the hydrogen protons and electrons are generated by an oxidation reaction of the hydrogen. Each of the generated hydrogen protons and electrons moves to the cathode through the polymer electrolyte membrane 60 and the separation plate 30. In the cathode, water, that is, moisture is generated by oxygen reduction reactions of the hydrogen protons, the electrons, and the oxygen and the power is generated by the flow of the electrons.

The separation plate 30 is low in electric resistance and high in chemical resistance and mechanical property and needs to be low in gas permeability to prevent leakage of the hydrogen and the oxygen. In addition, the electric contact resistance between two adjacent separation plates needs to be low. A material of the separation plate is constituted by graphite, expanded carbon, or stainless steel or adopts a polymer matrix composite in which carbon particles and graphite particles are added to a polymer matrix.

In recent years, in order to lower the electric contact resistance of the separation plate 30, the surface of the separation plate 30 is subjected to a flame treatment or a plasma treatment to expose carbon materials (carbon fibers), but there is a problem in that the carbon materials constituting the separation plate 30 are damaged.

### SUMMARY OF THE INVENTION

An object of the present invention is to provide a composite material separation plate for a fuel cell and a method for manufacturing the same which reduce electric contact resistance of a separation plate by exposing carbon materials of the separation plate by physical contact between a sacrificial layer of a soft material and the separation plate.

Further, another object of the present invention is to provide a composite material separation plate for a fuel cell and a method for manufacturing the same which reduce the electric contact resistance of the separation plate by contacting the sacrificial layer made of the soft material with a preliminary separation plate and exposing the carbon materials on the surface of a separation membrane through pressing the sacrificial layer.

In addition, yet another object of the present invention is to provide a composite material separation plate for a fuel cell and a method for manufacturing the same which can reduce electric contact resistance and decrease the number of components by forming a first region where the carbon materials are exposed and a second region where the carbon materials are covered with a polymer matrix on a circumference of the first region.

In order to solve the problem in the related art, a composite material separation plate for a fuel cell according to the present invention includes carbon materials covered with a polymer matrix, in which the carbon materials are exposed on the surface of the composite material separation plate.

Here, the composite material separation plate includes a conductive region where the carbon materials are exposed and a non-conductive region where the carbon materials are covered with the polymer matrix on the circumference of the conductive region, the conductive region includes a first conductive region formed on one surface of the composite material separation plate and a second conductive region formed on the other surface of the composite material separation plate, and electric contact resistance of the conductive region is smaller than the electric contact resistance of the non-conductive region.

Moreover, a thickness of a separation plate corresponding to the conductive region is smaller than the thickness of the separation plate corresponding to the non-conductive region, in the non-conductive region, the carbon materials are covered with the polymer matrix and the carbon material is any one or two or more of a carbon long fiber, a carbon short fiber, a carbon felt, a carbon nanotube, carbon black, and graphene. Further, the polymer resin may be at least one of a thermosetting resin, a thermoplastic resin, and an elastomer and moreover, when the separation plate is used in a strong oxidation environment, the polymer resin may be a fluorine-based resin.

In addition, a method for manufacturing a composite material separation plate for a fuel cell according to the present invention includes: forming a preliminary separation plate by covering carbon materials with a polymer matrix; exposing the carbon materials in a region of the preliminary separation plate contacting a sacrificial layer by locating the sacrificial layer on the preliminary separation plate and performing pressing and curing processes; and completing a separation plate by removing the sacrificial layer.

Here, the sacrificial layer is polyethylene, polypropylene, or an elastomer, the sacrificial layer is a polytetrafluoroethylene (PTFE) film or a silicon sheet, the sacrificial layer has a heterogeneous material characteristic with the preliminary separation plate, the preliminary separation plate is partitioned into a conductive region and a non-conductive region, and the sacrificial layer is located to correspond to the conductive region and is subjected to the pressing and curing processes.

Moreover, the conductive region of the separation plate has an exposure part where the carbon materials are exposed to the outside, in the non-conductive region of the separation plate, the polymer matrix covers the carbon materials, electric contact resistance of the conductive region of the separation plate is smaller than the electric contact resistance of the non-conductive region of the separation plate, a thickness of the conductive region of the separation plate is smaller than the thickness of the non-conductive region of the separation plate, and the carbon material is any one or two or more of a carbon long fiber, a carbon short fiber, a carbon felt, a carbon nanotube, carbon black, and graphene. Further, the polymer resin may be at least one of a thermosetting resin, a thermoplastic resin, and an elastomer and moreover, when the separation plate is used in a strong oxidation environment, the polymer resin may be a fluorine-based resin.

### BRIEF DESCRIPTION OF THE DRAWINGS

In order to help understanding of the present invention, the accompanying drawings which are included as a part of the Detailed Description provide embodiments of the present invention and describe the technical spirit of the present invention together with the Detailed Description.

FIG. 1 is a diagram schematically illustrating a configuration of a polymer electrolyte fuel cell stack.

FIG. 2A and FIG. 2B are diagrams illustrating a process of manufacturing a composite material separation plate for a fuel cell according to a first embodiment of the present invention.

FIG. 3A and FIG. 3B are diagrams for describing a principle in which carbon materials are exposed onto the surface of a composite material separation plate for a fuel cell according to the first embodiment of the present invention.

FIG. 4 is a diagram illustrating a process of manufacturing a composite material separation plate for a fuel cell according to a second embodiment of the present invention.

FIG. 5 is a diagram illustrating a structure of a separation plate manufactured according to the second embodiment of FIG. 4.

FIGS. 6A and 6B are cross-sectional views of regions A and B of FIG. 5.

FIG. 7 is a diagram illustrating a configuration of a polymer electrolyte fuel cell stack according to the present invention.

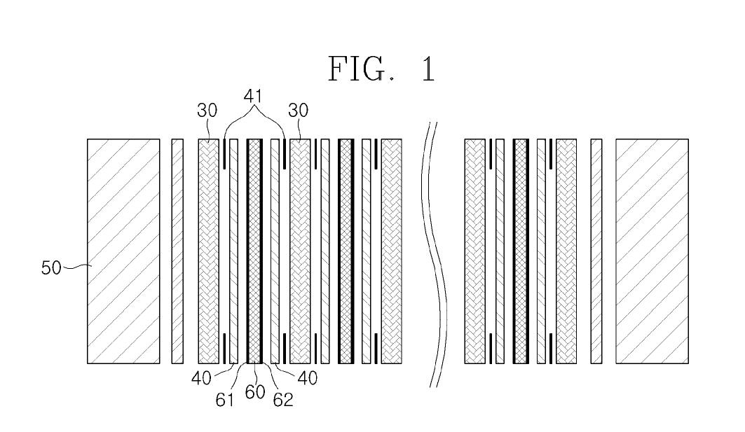

### DETAILED DESCRIPTION

Advantages and features of the present invention, and methods for accomplishing the same will be more clearly understood from exemplary embodiments described in detail below with reference to the accompanying drawings. However, the present invention is not limited to the following exemplary embodiments but may be implemented in various different forms. The exemplary embodiments are provided only to complete disclosure of the present invention and to fully provide a person having ordinary skill in the art to which the present invention pertains with the category of the invention, and the present invention will be defined only by the appended claims.

The shapes, sizes, ratios, angles, numbers, and the like illustrated in the drawings for describing the exemplary embodiments of the present invention are merely examples, and the present invention is not limited thereto. Throughout the whole specification, the same reference numerals denote the same elements. Further, in describing the present invention, a detailed explanation of known related technologies may be omitted to avoid unnecessarily obscuring the subject matter of the present invention.

The terms such as “including,” “having,” and “consisting of” used herein are generally intended to allow other components to be added unless the terms are used with “only”. When a component is expressed as singular form, any references to the singular form may include plural form unless expressly stated otherwise.

Components are interpreted to include an ordinary error range even if not expressly stated.

When the position relation between two parts is described using the terms such as “on”, “above”, “below”, and “next”, one or more other parts may be positioned between the two parts unless the terms are used with the term “immediately” or “directly”.

In the case of a description of a time relation, for example, when a time order relation is described using the terms such as “after”, “subsequent to”, “next to”, and “before”, the case may include a case where the time order relation is not continuous unless the terms are used with the term “immediately” or “directly”.

Although the terms “first”, “second”, and the like are used for describing various components, these components are not confined by these terms. These terms are merely used for distinguishing one component from another component. Therefore, a first component to be mentioned below may be a second component in a technical concept of the present invention.

The features of various embodiments of the present invention can be partially or entirely coupled to or combined with each other and can be interlocked and operated in technically various ways, and the embodiments can be carried out independently of or in association with each other.

Hereinafter, embodiments of the present invention will be described in detail with reference to drawings. In addition, in the drawings, the size and the thickness of an apparatus may be exaggerated and expressed for easy description. Like reference numerals designate like elements throughout the specification.

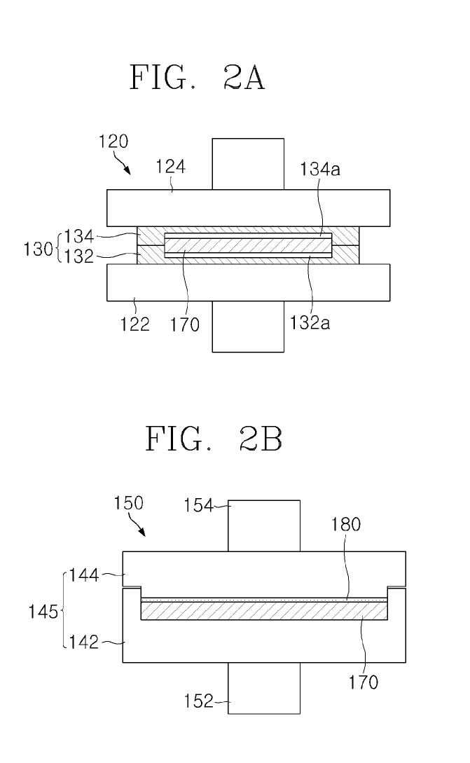

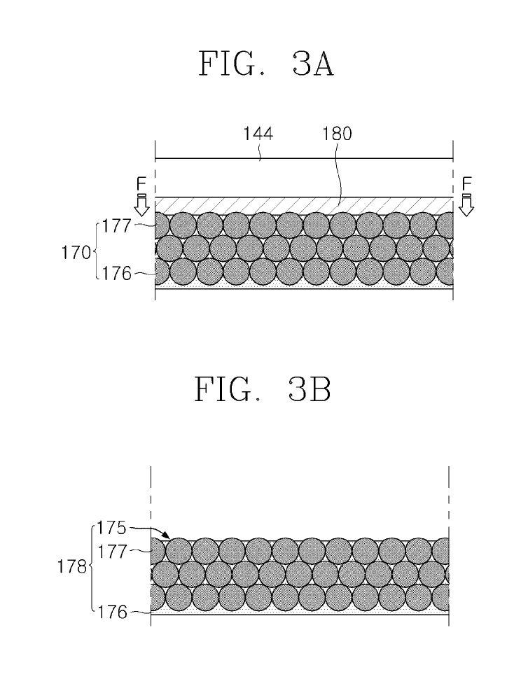

FIG. 2A and FIG. 2B are diagrams illustrating a process of manufacturing a composite material separation plate for a fuel cell according to a first embodiment of the present invention and FIGS. 3A and 3B are diagrams for describing a principle in which carbon materials are exposed onto the surface of a composite material separation plate for a fuel cell according to the first embodiment of the present invention.

First, although not illustrated in the drawings, in the composite material separation plate, carbon materials 177 are manufactured in the form of a roll and thereafter, cut in a length unit required for manufacturing the separation plate by a cutting roller. The cut carbon materials 177 have a form of a carbon material made sheet (not illustrated) and the composite material separation plate is manufactured by impregnating the polymer resin in the cut carbon materials 177.

Therefore, the composite material separation plate means a composite material reinforced with a conductive carbon material, that is, a composite material into which one or two types of conductive carbon materials such as a carbon long fiber, a carbon short fiber, a carbon felt, a carbon nanotube, carbon black, and graphene are inserted with the polymer resin as the matrix. Further, a metal short fiber or metal powder may be additionally mixed in the composite material separation plate together with carbon materials.

As the polymer resin, a thermosetting resin such as epoxy, phenol, or the like, a thermoplastic resin such as PE, PP, PEEK, or the like, or an elastomer such as silicone, fluorine silicone, fluorine rubber, butyl rubber, or the like may be used. When the separation plate is used in a strong oxidizing environment, it is preferable to use a fluorine-based matrix.

As described above, a process is performed, in which the cut carbon material made sheet is loaded on the hot press machine 120 illustrated in FIG. 2A and then, the polymer matrix 176 is injected into the carbon material made sheet.

Hereinafter, a process for manufacturing a composite material separation plate for a fuel cell of the present invention will be described in detail with reference to FIGS. 2A, 2B, 3A and 3B.

Referring to FIGS. 2A, 2B, 3A and 3B, a hot press machine 120 includes a first table 122, a first ram 124, and a mold assembly 130. The mold assembly 130 includes a lower mold 132 seated on the first table 122 and an upper mold 134 fixed on a lower surface of the first ram 124 and a carbon material made sheet cut in a predetermined length enters a lower capacity 132a of the lower mold 132.

An upper cavity 134a is also formed in the upper mold 134 so as to correspond to the lower cavity 132a of the lower mold 132. Further, in order to form channels for the flow of fuel, water, and air, channel patterns may be formed on inner surfaces of the lower mold 132 and the upper mold 134 corresponding to the lower cavity 132a and the upper cavity 134a, respectively.

The channel patterns form multiple uneven grooves on the surface of a separation plate during a pressing process of the hot press machine 120 so that the fuel, the water, and the air may flow.

As described above, when the carbon material made sheet enters the lower mold 132 of the mold assembly 130, a process of injecting a polymer matrix 176 is performed even though not illustrated in the drawing.

The process of injecting the polymer matrix 176 may be performed by injecting a resin onto the carbon material made sheet disposed in the cavity 132a of the lower mold 132.

As described above, by impregnating the polymer matrix 176 with the carbon material made sheet by the resin injection of the polymer matrix 176, a time required for the process is shortened to enhance productivity.

In the embodiment, the carbon material made sheet impregnated with the polymer matrix 20 may be composed of a prepreg, and the prepreg may be manufactured as a laminate or sheet by impregnating the polymer matrix 176 with the carbon materials and curing the carbon materials in a B-stage.

When the carbon material made sheet is impregnated with the polymer matrix 176 as described above, the hot press machine 120 is operated to mold a preliminary separation plate 170 by consolidation and curing processes toward the upper mold 134 and the lower mold 132 of the mold assembly 130. The consolidation of the carbon material made sheet may be performed by pressing the upper mold 134 by lowering the first ram 124 or simultaneously pressing the upper mold 134 and the lower mold 132 by lowering the first ram 124 and raising a first table 122. A molding temperature of the hot press machine 120 may be controlled according to a curing temperature of the polymer matrix 176.

As described above, when the consolidation and curing processes of the carbon material made sheet are completed, the upper mold 134 and the lower mold 132 are opened to take out the preliminary separation plate 170 from the mold assembly 130.

Meanwhile, the curing of the polymer matrix 176, for example, a thermosetting resin, is performed in such a manner that by raising an ambient temperature to approximately 80 to 400° C. to impart thermal energy, a resin having a monomer form is cross-linked or a resin in the B-stage is melted and then is changed from a liquid to a solid by a cross-linking reaction. The curing of the thermoplastic resin is accomplished in such a manner that the resin is completely melted by imparting the thermal energy and charged in a carbon material made interface and is again changed to the solid when a temperature is lowered.

Further, in addition to an impregnation process of the polymer matrix 176 described above, the impregnation process by resin transfer molding may be performed. In the resin transfer type impregnation process, the carbon material made sheet enters the lower cavity 132a of the lower mold 132 of the hot press machine 120 and then, the upper mold 134 is lowered to close the upper mold 134 and the lower mold 132.

Thereafter, the polymer matrix 176 is injected and sprayed through an injection port (not illustrated) disposed on the inner surface of the upper mold 134, and then, the carbon material made sheet is subjected to the consolidation and curing processes to complete the preliminary separation plate 170.

As described above, when the preliminary separation plate 170 is completed, the preliminary separation plate 170 is loaded to a first trimming machine 150 as illustrated in FIG. 2B.

The first trimming machine 150 includes a second table 152, a second ram 154, and a first trimming mold assembly 145. The first trimming mold assembly 145 includes a first trimming lower mold 142 and a first trimming upper mold 144 that are seated on the second table 152.

The first trimming machine 150 punches or cuts the preliminary separation plate 170 or in the present invention, the first trimming machine 150 additionally performs a process of exposing carbon materials 177 on the surface of the preliminary separation plate 170 in order to reduce the electric contact resistance of the separation plate.

When the preliminary separation plate 170 is seated inside the first trimming lower mold 142, the sacrificial layer 180 is positioned between the lower surface of the first trimming upper mold 144 and the preliminary separation plate 170. In this case, the sacrificial layer 180 which is made of the soft material having low rigidity may be coated on the lower surface of the first trimming upper mold 144 or may be stacked and disposed on the preliminary separation plate 170 as a rectangular plate shaped sheet similar to the shape of the preliminary separation plate 170.

Therefore, when the sacrificial layer 180 is coated on the lower surface of the first trimming upper mold 144, the sacrificial layer 180 may be formed by using a polymer resin such as polyethylene or polypropylene or a material of an elastomer such as silicon or rubber.

In the case of a sheet structure in which the sacrificial layer 180 is stacked on the preliminary separation plate 170, a polytetrafluoroethylene (PTFE) film or a silicon sheet may be used.

Further, the sacrificial layer 180 is excellent in bonding or adhesion characteristics with the first trimming upper mold 144 before curing and is easily separated from the preliminary separation plate 170 after curing.

The sacrificial layer 180 may have a heterogeneous material characteristic with the preliminary separation plate 170 for easy separation of the preliminary separation plate 170 and the sacrificial layer 180.

When the preliminary separation plate 170 and the sacrificial layer 180 are positioned in the first trimming lower mold 142 as described above, the first trimming machine 150 is operated to perform the consolidation and curing processes of the first trimming upper mold 144 of the first trimming mold assembly 145 toward the first trimming lower mold 142.

The process of consolidating the sacrificial layer 180 may be performed by pressing the first trimming upper mold 144 by lowering the second ram 2 or simultaneously pressing the first trimming upper mold 144 and the second trimming lower mold 142 by lowering the second ram 154 and raising the second table 152.

Referring to FIGS. 2A, 2B, 3A and 3B, when the first trimming upper mold 144 is pressed toward the preliminary separation plate 170, force is applied to the lower surface of the first trimming upper mold 144 toward the sacrificial layer 180 and the preliminary separation plate 170.

In this case, the sacrificial layer 180 located on the lower surface of the first trimming upper mold 144 and between the preliminary separation plate 170 and the first trimming upper mold 144 pushes the polymer matrix 176 covering spaces among the carbon materials 177 which exist in an upper region of the preliminary separation plate 170 and the carbon materials 177 toward the first trimming lower mold 142.

More specifically, each of the carbon materials 177 has a radius of approximately 2.5 to 3.5 [μu] m and is covered by the polymer matrix 176 or filled between the carbon materials 177.

The polymer matrix 176 of the preliminary separation plate 170 is consolidated toward the trimming lower mold 142 (toward a lower part of the preliminary separation plate) by the sacrificial layer on the upper surface of the preliminary separation plate 170 which is in contact with the sacrificial layer 180, and as a result, some of the carbon materials 177 in the upper region of the preliminary separation plate 170 are exposed to the outside.

As described above, when the sacrificial layer 180 is cured by the curing process in a state where some of the carbon materials 177 of the preliminary separation plate 170 are exposed to the outside, multiple uneven grooves are formed on the lower surface of the sacrificial layer 180 by the carbon materials 177 as illustrated in FIG. 3A.

The multiple uneven grooves formed on the lower surface of the sacrificial layer 180 cover the carbon materials 177 exposed on the upper surface of the preliminary separation plate 170 and since the sacrificial layer 180 is cured, the exposed state of the carbon materials 177 remains unchanged.

Thereafter, as illustrated in FIG. 3B, when the sacrificial layer 180 cured on the preliminary separation plate 170 is removed, the carbon materials 177, the polymer matrix 176, and a separation plate 178 having an exposure part 175 on the upper surface thereof are completed.

Since the sacrificial layer 180 is excellent in adhesion properties with a mold before curing, but since the sacrificial layer 180 is made of a heterogeneous material with the carbon materials 177 and the polymer matrix 176 constituting the separation plate 178 after curing, the sacrificial layer 180 may be easily separated without damaging the separation plate 178.

FIGS. 2A and 2B are diagrams illustrating a process of manufacturing a composite material separation plate for a fuel cell according to a first embodiment of the present invention and FIGS. 3A and 3B are diagram for describing a principle in which carbon materials are exposed onto the surface of a composite material separation plate for a fuel cell according to the first embodiment of the present invention.

First, although not illustrated in the drawings, in the composite material separation plate, carbon materials 177 are manufactured in the form of a roll and thereafter, cut in a length unit required for manufacturing the separation plate by a cutting roller. The cut carbon materials 177 have a form of the carbon material made sheet (not illustrated) and the composite material separation plate is manufactured by impregnating the polymer resin in the cut carbon materials 177.

Therefore, the composite material separation plate means a composite material reinforced with a conductive carbon material, that is, a composite material into which one or two types of conductive carbon materials such as a carbon long fiber, a carbon short fiber, a carbon felt, a carbon nanotube, carbon black, and graphene are inserted with the polymer resin as the matrix. Further, a metal short fiber or metal powder may be additionally mixed in the composite material separation plate together with carbon materials.

As the polymer resin, a thermosetting resin such as epoxy, phenol, or the like, a thermoplastic resin such as PE, PP, PEEK, or the like, or an elastomer such as silicone, fluorine silicone, fluorine rubber, butyl rubber, or the like may be used. When the separation plate is used in a strong oxidizing environment, it is preferable to use a fluorine-based matrix.

As described above, a process is performed, in which the cut carbon material made sheet is loaded on the hot press machine 120 illustrated in FIGS. 2A and 2B and then, the polymer matrix 176 is injected into the carbon material made sheet.

Hereinafter, the process for manufacturing a composite material separation plate for a fuel cell of the present invention will be described in detail with reference to FIGS. 2A, 2B, 3A and 3B.

Referring to FIGS. 2A, 2B, 3A and 3B, the hot press machine 120 includes a first table 122, a first ram 124, and a mold assembly 130. The mold assembly 130 includes a lower mold 132 seated on the first table 122 and an upper mold 134 fixed on a lower surface of the first ram 124 and a carbon material made sheet cut in a predetermined length enters a lower capacity 132a of the lower mold 132.

An upper cavity 134a is also formed in the upper mold 134 so as to correspond to the lower cavity 132a of the lower mold 132. Further, in order to form channels for the flow of fuel, water, and air, channel patterns may be formed on inner surfaces of the lower mold 132 and the upper mold 134 corresponding to the lower cavity 132a and the upper cavity 134a, respectively.

The channel patterns form multiple uneven grooves on the surface of a separation plate during a pressing process of the hot press machine 120 so that the fuel, the water, and the air may flow.

As described above, when the carbon material made sheet enters the lower mold 132 of the mold assembly 130, a process of injecting a polymer matrix 176 is performed even though not illustrated.

The process of injecting the polymer matrix 176 may be performed by spraying a resin onto the carbon material made sheet disposed in the cavity 132a of the lower mold 132.

As described above, by impregnating the carbon material made sheet with the polymer matrix 176 by the resin spray of the polymer matrix 176, a time required for the process is shortened to enhance productivity.

In the embodiment, the carbon material made sheet impregnated with the polymer matrix 20 may be composed of a prepreg, and the prepreg is manufactured as a laminate or sheet by impregnating the polymer matrix 176 with the carbon materials and curing the carbon materials in a B-stage.

When the polymer matrix 176 is impregnated with the carbon material made sheet as described above, the hot press machine 120 is operated to form a preliminary separation plate 170 by consolidation and curing processes toward the upper mold 134 and the lower mold 132 of the mold assembly 130. The consolidation of the carbon material made sheet may be performed by pressing the upper mold 134 by lowering the first ram 124 or simultaneously pressing the upper mold 134 and the lower mold 132 by lowering the first ram 124 and raising a first table 122. A molding temperature of the hot press machine 120 may be controlled according to a curing temperature of the polymer matrix 176.

As described above, when the consolidation and curing processes of the carbon material made sheet are completed, the upper mold 134 and the lower mold 132 are opened to take out the preliminary separation plate 170 from the mold assembly 130.

Meanwhile, the curing of the polymer matrix 176, for example, a thermosetting resin, is performed in such a manner that by raising an ambient temperature to approximately 80 to 400° C. to impart thermal energy, a resin having a monomer form is cross-linked or a resin in the B-stage is melted and then is changed from a liquid to a solid by a cross-linking reaction. The curing of the thermoplastic resin is accomplished in such a manner that the resin is completely melted by imparting the thermal energy and charged in a carbon material made interface and is again changed to the solid when a temperature is lowered.

Further, in addition to an impregnation process of the polymer matrix 176 described above, the impregnation process by resin transfer molding may be performed. In the resin transfer type impregnation process, the carbon material made sheet enters the lower cavity 132a of the lower mold 132 of the hot press machine 120 and then, the upper mold 134 is lowered to close the upper mold 134 and the lower mold 132.

Thereafter, the polymer matrix 176 is injected and sprayed through an injection port (not illustrated) disposed on the inner surface of the upper mold 134, and then, the carbon material made sheet is subjected to the consolidation and curing processes to complete the preliminary separation plate 170.

As described above, when the preliminary separation plate 170 is completed, the preliminary separation plate 170 is loaded to a first trimming machine 150 as illustrated in FIG. 2B.

The first trimming machine 150 includes a second table 152, a second ram 154, and a first trimming mold assembly 145. The first trimming mold assembly 145 includes a first trimming lower mold 142 and a first trimming upper mold 144 that are seated on the second table 152.

The first trimming machine 150 punches or cuts the preliminary separation plate 170 or in the present invention, the first trimming machine 150 additionally performs a process of exposing carbon materials 177 on the surface of the preliminary separation plate 170 in order to reduce the electric contact resistance of the separation plate.

When the preliminary separation plate 170 is seated inside the first trimming lower mold 142, the sacrificial layer 180 is positioned between the lower surface of the first trimming upper mold 144 and the preliminary separation plate 170. In this case, the sacrificial layer 180 which is made of the soft material having low rigidity may be coated on the lower surface of the first trimming upper mold 144 or may be stacked and disposed on the preliminary separation plate 170 as a rectangular plate shaped sheet similar to the shape of the preliminary separation plate 170.

Therefore, when the sacrificial layer 180 is coated on the lower surface of the first trimming upper mold 144, the sacrificial layer 180 may be formed by using of a polymer resin such as polyethylene or polypropylene or a material of an elastomer such as silicon or rubber.

In the case of a sheet structure in which the sacrificial layer 180 is stacked on the preliminary separation plate 170, a polytetrafluoroethylene (PTFE) film or a silicon sheet may be used.

Further, the sacrificial layer 180 is excellent in bonding or adhesion characteristics with the first trimming upper mold 144 before curing and is easily separated from the preliminary separation plate 170 after curing.

The sacrificial layer 180 may have a heterogeneous material characteristic with the preliminary separation plate 170 for easy separation of the preliminary separation plate 170 and the sacrificial layer 180.

When the preliminary separation plate 170 and the sacrificial layer 180 are positioned in the first trimming lower mold 142 as described above, the first trimming machine 150 is operated to perform the consolidation and curing processes of the first trimming upper mold 144 of the first trimming mold assembly 145 toward the first trimming lower mold 142.

The process of consolidating the sacrificial layer 180 may be performed by pressing the first trimming upper mold 144 by lowering the second ram 154 or simultaneously pressing the first trimming upper mold 144 and the second trimming lower mold 142 by lowering the second ram 154 and raising the second table 152.

Referring to FIGS. 2A, 2B, 3A and 3B, when the first trimming upper mold 144 is pressed toward the preliminary separation plate 170, force is applied to the lower surface of the first trimming upper mold 144 toward the sacrificial layer 180 and the preliminary separation plate 170.

In this case, the sacrificial layer 180 located on the lower surface of the first trimming upper mold 144 and between the preliminary separation plate 170 and the first trimming upper mold 144 pushes the polymer matrix 176 covering spaces among the carbon materials 177 which exist in an upper region of the preliminary separation plate 170 and the carbon materials 177 toward the first trimming lower mold 142.

More specifically, each of the carbon materials 177 has a radius of approximately 2.5 to 3.5 [μm] and is covered by the polymer matrix 176 or filled between the carbon materials 177.

The polymer matrix 176 of the preliminary separation plate 170 is consolidated toward the trimming lower mold 142 (toward a lower part of the preliminary separation plate) by the sacrificial layer 180 on the upper surface of the preliminary separation plate 170 which is in contact with the sacrificial layer 180, and as a result, some of the carbon materials 177 in the upper region of the preliminary separation plate 170 are exposed to the outside.

As described above, when the sacrificial layer 180 is cured by the curing process in a state where some of the carbon materials 177 of the preliminary separation plate 170 are exposed to the outside, multiple uneven grooves are formed on the lower surface of the sacrificial layer 180 by the carbon materials 177 as illustrated in FIG. 3A.

The multiple uneven grooves formed on the lower surface of the sacrificial layer 180 cover the carbon materials 177 exposed on the upper surface of the preliminary separation plate 170 and since the sacrificial layer 180 is cured, the exposed state of the carbon materials 177 remains unchanged.

Thereafter, as illustrated in FIG. 3B, when the sacrificial layer 180 cured on the preliminary separation plate 170 is removed, the carbon materials 177, the polymer matrix 176, and a separation plate 178 having an exposure part 175 on the upper surface thereof are completed.

Since the sacrificial layer 180 is excellent in adhesion properties with a mold before curing, but since the sacrificial layer 180 is made of a heterogeneous material with the carbon materials 177 and the polymer matrix 176 constituting the separation plate 178 after curing, the sacrificial layer 180 may be easily separated without damaging the separation plate 178.

Therefore, since the polymer matrix 176 covering the carbon materials is partially removed from the outer surface of the composite material separation plate for a fuel cell according to the present invention, there is an effect in which the composite material separation plate for a fuel cell according to the present invention has lower electric contact resistance than a region where the carbon materials 177 are covered by the polymer matrix 176.

Further, in the above description, it is primarily described that the sacrificial layer 180 is disposed between the preliminary separation plate 170 and the first trimming upper mold 144. However, in some cases, a second sacrificial layer is additionally disposed between the first trimming lower mold 142 and the preliminary separation plate 170 to expose the carbon materials on the upper and lower surfaces of the preliminary separation plate 180, thereby reducing the electric contact resistance.

As described above, according to the present invention, there is an effect in which the carbon materials of the separation plate are exposed to the outside without damaging the carbon materials by using the sacrificial layer made of the soft material without direct flame treatment or plasma treatment on the separation plate like the related art, thereby lowering the electric contact resistance of the separation plate.

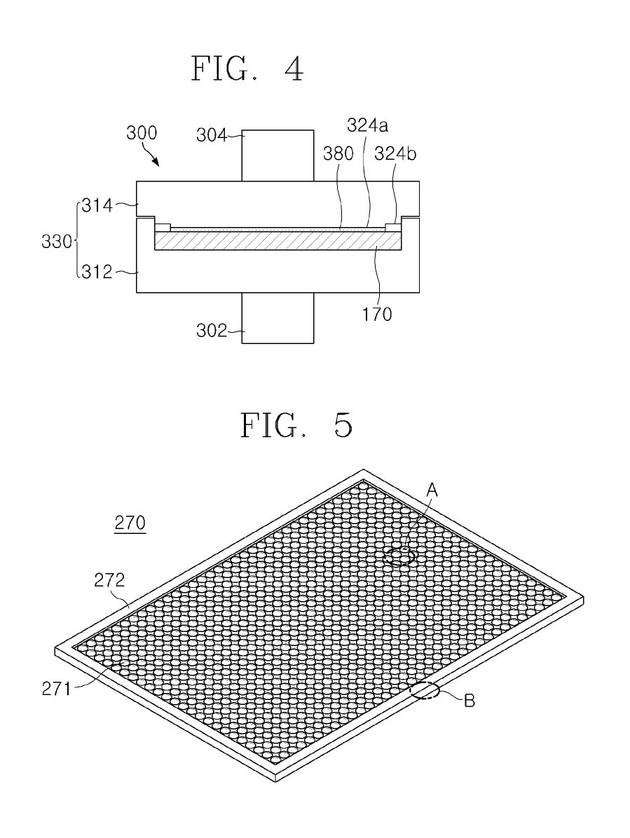

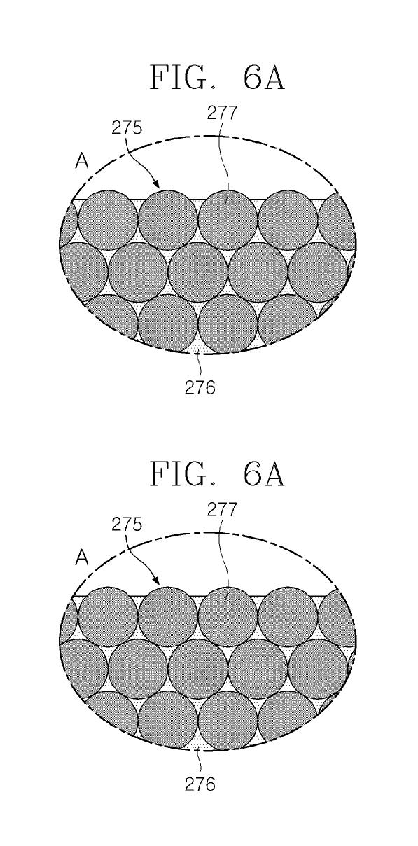

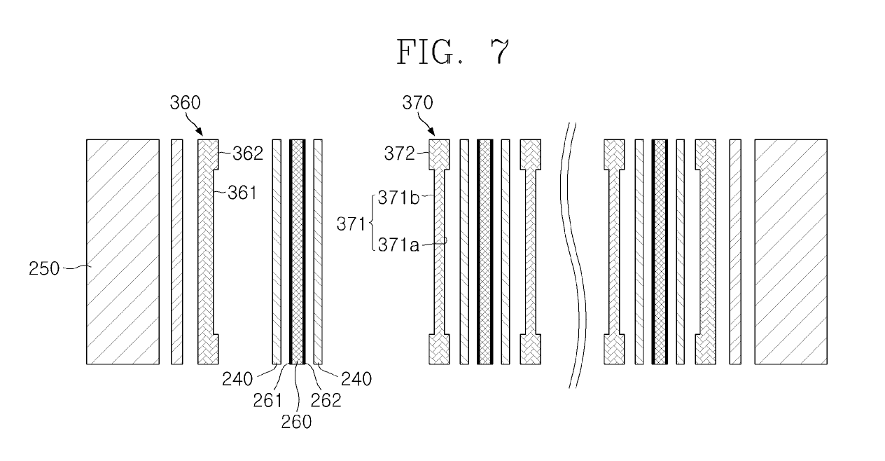

FIG. 4 is a diagram illustrating a process of manufacturing a composite material separation plate for a fuel cell according to a second embodiment of the present invention, FIG. 5 is a diagram illustrating a structure of a separation plate manufactured according to the second embodiment of FIG. 4, and FIGS. 6A and 6B are cross-sectional views of regions A and B of FIG. 5.

Since the process for manufacturing the preliminary separation plate is the same as the process described in the first embodiment, a separation plate manufacturing process in which regions having different electric contact resistance are formed in the separation plate by using the sacrificial layer will now be primarily described.

Referring to FIGS. 4 to 6B, in the process for manufacturing a composite material separation plate for a fuel cell according to the second embodiment of the present invention, when the preliminary separation plate 170 is completed, a second trimming machine 300 enters the preliminary separation plate 170 as described in the first embodiment of the present invention.

The second trimming machine 300 includes a third table 302, a third ram 304, and a second trimming mold assembly 330. The second trimming mold assembly 330 includes a second trimming lower mold 312 and a second trimming upper mold 314 that are seated on the third table 302.

Particularly, the lower part of the second trimming upper mold 314 of the second embodiment of the present invention is constituted by a first surface 324a and a second surface 324b unlike the structure of the trimming machine of the first embodiment. The first surface 324a has a flat surface structure parallel to the inner surface of the second trimming lower mold 312 and the second surface 324b is a flat surface formed in a step region formed on the periphery of the first surface 324a.

Accordingly, the second surface 324b is located above the first surface 324a by a step height.

The second trimming machine 300 punches or cuts the preliminary separation plate 170 or in the present invention, the second trimming machine 300 additionally performs a process of exposing carbon materials 277 on the surface of the preliminary separation plate 170 in order to reduce the contact resistance of the separation plate.

When the preliminary separation plate 170 is seated inside the second trimming lower mold 312, a sacrificial layer 380 is positioned between the lower surface of the second trimming upper mold 314 and the preliminary separation plate 170.

In this case, the sacrificial layer 380 which is made of the soft material having low rigidity may be formed on the lower surface of the first region 324a of the second trimming upper mold 314 or may be stacked and disposed on the preliminary separation plate 170 in a rectangular plate shaped sheet shape similar to the shape of the preliminary separation plate 170.

That is, in the second embodiment of the present invention, the sacrificial layer 380 is formed only in a region corresponding to the first region 324a of the second trimming upper mold 314 or has a rectangular plate shaped sheet structure corresponding to the first region 324a.

The material of the sacrificial layer 380 has the characteristic described in the first embodiment and may adopt a polymer resin such as polyethylene or polypropylene, an elastomer such as silicone or rubber, or a polytetrafluoroethylene (PTFE) film or a silicon sheet.

When the preliminary separation plate 170 and the sacrificial layer 380 are disposed in the second trimming lower mold 312 as described above, the second trimming machine 300 is operated to perform the consolidation and curing processes of the second trimming upper mold 314 of the second trimming mold assembly 330 toward the second trimming lower mold 312.

The process of consolidating the sacrificial layer 380 may be performed by pressing the second trimming upper mold 314 by lowering the third ram 304 or simultaneously pressing the second trimming upper mold 314 and the second trimming lower mold 312 by lowering the third ram 304 and raising the third table 302.

When the consolidation and curing processes are performed on the sacrificial layer 380 as described above, a separation plate 270 is completed, in which carbon materials 277 are exposed to the outside is completed on the upper surface of the preliminary separation plate 170 according to the principle described in FIGS. 3A and 3B.

The separating plate 270 according to the second embodiment of the present invention is divided into a conductive region 271 corresponding to the first region 324 of the second trimming upper mold 314 and a non-conductive region 272 formed on the circumference of the separation plate 270 around the conductive region 271.

Referring to FIGS. 6A and 6B, the conductive region 271 of the separation plate 270 includes an exposure part 275 in which the carbon materials 277 are exposed, carbon materials 277, and a polymer matrix 276 as illustrated in region A and the non-conductive region 272 of the separation plate 270 has a structure in which the carbon materials 277 are impregnated in the polymer matrix 276, and the carbon materials 277 are not exposed to the outside as illustrated in region B.

That is, the separation plate 270 according to the second embodiment of the present invention is divided into the conductive region 271 and the non-conductive region 272 having different electric contact resistance and the conductive region 271 has low electric contact resistance because the carbon materials 277 are exposed to the outside.

The non-conductive region 272 has a structure in which the carbon materials 277 are surrounded by the polymer matrix 276, and as a result, the non-conductive region 272 has relatively larger electric contact resistance than the conductive region 271.

Although the structure of one surface of the separation plate 270 is primarily described in the second embodiment of the present invention, the conductive region where the carbon materials 277 are exposed and the non-conductive region formed on the periphery of the conductive region may be formed even on the lower surface corresponding to the upper surface structure of the separation plate 270 illustrated in FIG. 5.

Accordingly, the conductive region where the carbon materials are exposed are formed on the upper and lower (both) surfaces of the separation plate 270 and the non-conductive region is formed on the circumference of the conductive region.

A thickness of the conductive region 271 of the separation plate 270 is smaller than the thickness of the non-conductive region 272 and the non-conductive region 272 is a region where gaskets are stacked in the related art, and in the present invention, the non-conductive region 272 of the separation plate 270 serves as the gasket that prevents gas and a cooling liquid from leaking between the separation plates 270.

Accordingly, in the polymer electrolyte fuel cell of the present invention, the conductive region and the non-conductive region may be formed in the separation plate and the non-conductive region serves as the gasket to implement a gasket integrated separation plate.

Hereinbelow, FIG. 7 illustrates a case where the separation plate 270 according to the second embodiment of the present invention is applied to a polymer electrolyte fuel cell.

FIG. 7 is a diagram illustrating a configuration of a polymer electrolyte fuel cell stack according to the present invention.

Referring to FIG. 7, one unit cell unit constituting the stack of the PEMFC of the present invention includes a membrane electrode assembly (MEA) at the innermost side thereof, a solid polymer electrolyte membrane 260, a cathode 261 and an anode 262 disposed on both surfaces of the polymer electrolyte membrane 260, a gas diffusion layer 240 disposed outside the cathode 261 and the anode 262, a first separation plate 360, a second separation plate 370, and an end plate 250 disposed at the outermost side thereof.

In particular, as described in the second embodiment, the polymer electrolyte fuel cell stack of the present invention includes the first separation plate 360 including a conductive region 361 on one surface thereof and a non-conductive region 362 formed on the periphery of the conductive region 361 and the second separation plate 370 including a first conductive region 371a and a second conductive region 371b on both surfaces, respectively, and a non-conductive region 372 formed on the circumference of the first and second conductive regions 371a and 371b.

As illustrated in FIG. 7, in a region facing the end plate 250 disposed at the outermost side of the polymer electrolyte fuel cell stack, the first separation plate 360 having the conductive region 361 and the non-conductive region 362 is disposed on one surface and the conductive region 361 of the first separation plate 360 faces the gas diffusion layer 240 adjacent thereto.

Further, the second separation plate 370 is disposed on each of both sides of the solid polymer electrolyte membrane 260 in a region between the first separation plates 360. The second separation plate 370 includes the first and second conductive regions 371a and 371b on one surface and the other surface (upper surface and lower surface), respectively and has the non-conductive region 372 on the circumference of the first and second conductive regions 371a and 371b.

Since the gas diffusion layers 240 are disposed in the region where the second separation plate 370 is disposed so as to face each other toward both sides of the second separation plate 370, the first and second conductive regions 371a and 371b have a structure in which the carbon materials are exposed to the outside in order to reduce the electric contact resistance with the gas diffusion layer 240.

The non-conductive region 372 in which the carbon materials are impregnated by the polymer matrix is formed on the circumference of the first and second conductive regions 371a and 371b of the second separation plate 370.

Therefore, since the first and second separation plates 360 and 370 manufactured according to the second embodiment of the present invention have the nonconductive regions 362 and 372 integrally formed on edge regions, respectively, the polymer electrolyte fuel cell stack of the present invention does not require a separate gasket.

That is, the polymer electrolyte fuel cell of the present invention includes the separation plate having the conductive region in which the carbon materials are exposed to the outside and the non-conductive region for preventing leakage of the gas and the cooling liquid on the periphery of the conductive region, and as a result, electrical characteristics of the fuel cell can be improved and the fuel cell can be miniaturized.

A composite material separation plate for a fuel cell and a method for manufacturing the same according to the present invention reduce electric contact resistance of a separation plate by exposing carbon materials of the separation plate by physical contact between a sacrificial layer of soft material and the separation plate.

Further, a composite material separation plate for a fuel cell and a method for manufacturing the same according to the present invention reduce the electric contact resistance of the separation plate by contacting the sacrificial layer of the soft material with a preliminary separation plate and exposing the carbon materials on the surface of the separation plate through pressing the sacrificial layer.

In addition, a composite material separation plate for a fuel cell and a method for manufacturing the same according to the present invention reduce electric contact resistance and decrease the number of components by forming a first region where the carbon materials are exposed and a second region where the carbon materials are covered with a polymer matrix on a circumference of the first region.

1. A composite material separation plate for a fuel cell, comprising:
carbon materials covered with a polymer matrix,
wherein the carbon materials are exposed on the surface of the composite material separation plate.

2. The composite material separation plate of claim 1, wherein the composite material separation plate includes a conductive region where the carbon materials are exposed and a non-conductive region where the carbon materials are covered with the polymer matrix on the circumference of the conductive region.

3. The composite material separation plate of claim 2, wherein the conductive region includes a first conductive region formed on one surface of the composite material separation plate and a second conductive region formed on the other surface of the composite material separation plate.

4. The composite material separation plate of claim 2, wherein electric contact resistance of the conductive region is smaller than the electric contact resistance of the non-conductive region.

5. The composite material separation plate of claim 2, wherein a thickness of a separation plate corresponding to the conductive region is smaller than the thickness of the separation plate corresponding to the non-conductive region.

6. The composite material separation plate of claim 2, wherein in the non-conductive region, the carbon materials are covered with the polymer matrix.

7. The composite material separation plate of claim 1, wherein the carbon material is any one or two or more of a carbon long fiber, a carbon short fiber, a carbon felt, a carbon nanotube, carbon black, and graphene.

8. The composite material separation plate of claim 1, wherein the polymer resin is at least one of a thermosetting resin, a thermoplastic resin, and an elastomer.

9. The composite material separation plate of claim 1, wherein when the separation plate is used in a strong oxidation environment, the polymer resin is a fluorine-based resin.

10. A method for manufacturing a composite material separation plate for a fuel cell, the method comprising:
forming a preliminary separation plate by covering carbon materials with a polymer matrix;
exposing the carbon materials in a region of the preliminary separation plate contacting a sacrificial layer by locating the sacrificial layer on the preliminary separation plate and performing pressing and curing processes; and
completing a separation plate by removing the sacrificial layer.

11. The method of claim 10, wherein the sacrificial layer is polyethylene, polypropylene, or an elastomer.

12. The method of claim 10, wherein the sacrificial layer is a polytetrafluoroethylene (PTFE) film or a silicon sheet.

13. The method of claim 10, wherein the sacrificial layer has a heterogeneous material characteristic with the preliminary separation plate.

14. The method of claim 10, wherein the preliminary separation plate is partitioned into a conductive region and a non-conductive region, and
the sacrificial layer is located to correspond to the conductive region and is subjected to the pressing and curing processes.

15. The method of claim 14, wherein the conductive region of the separation plate has an exposure part where the carbon materials are exposed to the outside.

16. The method of claim 14, wherein in the non-conductive region of the separation plate, the polymer matrix covers the carbon materials.

17. The method of claim 14, wherein electric contact resistance of the conductive region of the separation plate is smaller than the electric contact resistance of the non-conductive region of the separation plate.

18. The method of claim 14, wherein a thickness of the conductive region of the separation plate is smaller than the thickness of the non-conductive region of the separation plate.

19. The method of claim 10, wherein the carbon material is any one or two or more of a carbon long fiber, a carbon short fiber, a carbon felt, a carbon nanotube, carbon black, and graphene.

20. The method of claim 10, wherein the polymer resin is at least one of a thermosetting resin, a thermoplastic resin, and an elastomer.

21. The method of claim 10, wherein when the separation plate is used in a strong oxidation environment, the polymer resin is a fluorine-based resin.
